(19) United States
(12) Patent Application Publication
(10) Pub. No.: US 2026/0153245 A1
(43) Pub. Date: Jun. 4, 2026

(54) COMPLETE DRAINAGE SYSTEM FOR CLOSED HOT WATER TANK AND COMPLETE DRAINAGE METHOD USING THE SAME

(71) Applicant: COWAY Co., Ltd., Gongju-si (KR)

(72) Inventors: Sijun PARK, Seoul (KR); Jonghwan SIM, Seoul (KR)

(73) Assignee: COWAY Co., Ltd., Gongju-si (KR)

(21) Appl. No.: 19/395,874

(22) Filed: Nov. 20, 2025

(30) Foreign Application Priority Data
Dec. 3, 2024 (KR) 10-2024-0177190

(51) Int. Cl. F24D 19/00; A47J 31/46; A47J 31/52; F24H 15/223; F24H 15/335

(52) U.S. Cl. CPC F24D 19/0092; A47J 31/465; A47J 31/468; A47J 31/5253; F24H 15/223; F24H 15/335

(57) ABSTRACT

A filter fastening module includes a frame part and a fastening part. The frame part is configured to form a receiving space in which the filter unit is received. The fastening part includes a fixing unit coupled to an upper portion of the frame part and a rotating unit coupled inside the fixing unit. In a state in which a lower projection of the filter unit is fixed to the frame part, the fixing unit and the rotating unit rotate relative to each other so that the fastening part moves downward and is coupled to an upper projection of the filter unit.

This application claims priority under 35 U.S.C. § 119 to Korean Patent Application No. 10-2024-0177190, filed on Dec. 3, 2024, the disclosure of which is incorporated by reference herein in its entirety.

### BACKGROUND OF THE INVENTION

### Technical Field

The present invention relates to a complete drainage system for a closed hot water tank and a complete drainage method using the same, and more particularly, the present invention relates to a complete drainage system for a closed hot water tank and a complete drainage method using the same, which include draining hot water stored in the hot water tank completely to an outside at regular intervals to effectively remove scale generated as the hot water is stored in the hot water tank.

### Discussion of the Related Art

Sterilization or cleaning system of a water purifier is an essential component to ensure the safe use of the water purifier, and various technologies are being developed for this purpose.

For example, Korean Patent Publication No. 10-2024-0029285 discloses a technology for removing scale substances generated inside the water purifier by controlling the discharge of supplied water. In addition, Korean Patent No. 10-1738066 discloses a technology for removing scale of a sterilization module through circulation of cleaning water.

As described above, technologies have been developed to remove scale generated inside a water purifier or a sterilization module by circulating or supplying supplied water or cleaning water.

However, removing scale through a system that circulates or supplies separate supplied water or cleaning water as described above requires a separate cleaning procedure, and thus professional work is needed, causing problems of time and cost.

In particular, in the case of a water purifier having a hot water tank in a closed structure, there is a significant problem in that scale is generated as hot water is stored inside the hot water tank for a long time. Therefore, there is a need for the development of a system capable of minimizing the generation of scale without performing a separate cleaning procedure by a professional.

### SUMMARY

Accordingly, the technical task of the invention is derived from these points, and exemplary embodiments of the present invention provide a complete drainage system for a closed hot water tank which includes completely draining hot water stored in the hot water tank to an outside at regular intervals to effectively remove scale generated as the hot water is stored in the hot water tank, thereby minimizing time and cost required for separate cleaning.

In addition, exemplary embodiments of the present invention also provide a complete drainage method using the complete drainage system.

According to one aspect of the present invention, a complete drainage system includes a hot water tank, a discharge unit, a drainage unit and a pump unit. Hot water is stored in the hot water tank. The discharge unit is configured to discharge the hot water to an outside for drinking. The drainage unit is configured to drain the hot water to the outside. The pump unit is connected between the hot water tank and the drainage unit. When a temperature of the hot water in the hot water tank reaches a preset temperature or lower at which the pump unit is not damaged, the hot water is completely drained to the drainage unit.

In an exemplary embodiment, the system may further include an inflow unit configured to provide warm purified water into the hot water tank. As the warm purified water is provided into the hot water tank, the temperature of the hot water stored in the hot water tank may decrease.

In an exemplary embodiment, the system may further include a hot water drainage unit additionally connected to the hot water tank without passing through the pump unit. When the hot water tank reaches a full-water level as the warm purified water is provided, the hot water stored in the hot water tank may be forcibly drained through the hot water drainage unit.

In an exemplary embodiment, the system may further include a first temperature sensor configured to sense the temperature of the hot water in the hot water tank. When the temperature of the hot water sensed by the first temperature sensor reaches the preset temperature or lower, the hot water may be drained through the pump unit and the drainage unit.

In an exemplary embodiment, the system may further include a water level sensor configured to sense a water level of the hot water tank. When the water level sensed by the water level sensor reaches a preset low-water level, drainage to the drainage unit may be stopped.

In an exemplary embodiment, when the temperature of the hot water stored in the hot water tank decreases over time and reaches the preset temperature or lower, the hot water may be drained through the pump unit and the drainage unit.

In an exemplary embodiment, the system may further include a cold water tank in which cold water is stored. The cold water may be discharged to the discharge unit for drinking, or may be mixed with the hot water discharged from the hot water tank and drained to the drainage unit.

In an exemplary embodiment, a hot water drainage line connected to the hot water tank and through which the hot water is discharged may be combined with a cold water drainage line connected to the cold water tank and through which the cold water is discharged, and may be then connected to the pump unit.

In an exemplary embodiment, a capacity of the hot water tank may be smaller than a capacity of the cold water tank.

In an exemplary embodiment, the complete drainage of the hot water in the hot water tank to the drainage unit may be performed at a predetermined cycle requiring cleaning of the hot water tank.

According to another aspect of the present invention, a complete drainage method includes sensing a temperature of hot water stored in a hot water tank, draining the hot water to a drainage unit, when the temperature of the hot water reaches a preset temperature or lower at which a pump unit is not damaged, stopping drainage to the drainage unit, when a water level of the hot water tank reaches a preset low-water level, and supplying warm purified water to the hot water tank up to a full-water level.

In an exemplary embodiment, the method may further include, before the step of sensing the temperature of the hot water, supplying warm purified water to the hot water tank. As the warm purified water is provided, the temperature of the hot water stored in the hot water tank may decrease.

In an exemplary embodiment, the method may further include, when the hot water tank reaches a full-water level as the warm purified water is provided, forcibly draining the hot water stored in the hot water tank through a hot water drainage unit.

In an exemplary embodiment, the method may further include, before the step of sensing the temperature of the hot water, maintaining the hot water stored in the hot water tank for a predetermined time. As the predetermined time elapses, the temperature of the hot water stored in the hot water tank may decrease.

According to still another aspect of the present invention, a complete drainage method includes draining hot water stored in a hot water tank and cold water stored in a cold water tank to a drainage unit at the same time, stopping drainage to the drainage unit, when a water level of the hot water tank reaches a preset low-water level, and supplying warm purified water to the hot water tank up to a full-water level.

In an exemplary embodiment, in the step of draining the hot water and the cold water to the drainage unit at the same time, the hot water discharged from the hot water tank and the cold water discharged from the cold water tank may be mixed with each other and drained to the drainage unit through the pump unit at a temperature equal to or lower than the preset temperature.

According to exemplary embodiments of the present invention, by completely draining hot water in the hot water tank to the outside at regular intervals, scale generated in the hot water tank may be effectively removed. In particular, in the case of a hot water tank having a closed structure, since hot water is stored in the hot water tank for a long period of time, the possibility of scale generation is high, and effective scale management may be achieved while omitting a separate cleaning operation.

In this case, if the hot water stored in the hot water tank is drained as it is, there is a high possibility of damaging the pump unit due to the high temperature. Therefore, by lowering the temperature of the hot water to a temperature equal to or lower than a temperature at which the pump unit is not damaged, and then draining the hot water stored in the hot water tank, damage to a piping system including the pump unit may be minimized.

As a method for lowering the temperature of the hot water, warm purified water may be provided to the hot water tank so that the temperature is lowered by mixing with the hot water, or the temperature may be naturally lowered by allowing the hot water stored in the hot water tank to stand for a predetermined time. In particular, when the warm purified water is provided, if the water level of the hot water tank reaches a full-water level due to the provision of the warm purified water, the temperature of the hot water stored in the hot water tank may be effectively lowered to a preset temperature or lower by forcibly draining the hot water to the outside.

Alternatively, without providing separate warm purified water or waiting for a lapse of time, the temperature of the hot water provided to the pump unit may be directly lowered to a preset temperature or lower by draining mixed water in which the hot water discharged from the hot water tank and cold water discharged from a cold water tank are mixed, thereby simply and effectively achieving complete drainage of the hot water in the hot water tank.

In particular, in this case, when the hot water of the hot water tank and the cold water of the cold water tank are mixed, a low temperature that does not damage the pump unit may be obtained without separate temperature sensing, so that more direct and faster drainage of hot water may be achieved.

Meanwhile, it is sufficient that the hot water in the hot water tank is drained to a preset low-water level, and by measuring the water level of the hot water tank through a separate water level sensor, the completion time point of complete drainage may be accurately determined.

In particular, when drainage is performed by mixing with cold water, if the hot water tank is formed to have a smaller size than the cold water tank, the temperature of the hot water mixed with the cold water provided to the pump unit until the hot water tank reaches the low-water level is maintained at a preset temperature or lower, thereby implementing stable complete drainage while minimizing the possibility of damage to the pump unit.

### BRIEF DESCRIPTION OF THE DRAWINGS

FIG. 1 is a schematic diagram illustrating a complete drainage system for a closed hot water tank according to an example embodiment of the invention;

FIG. 2 is a flowchart illustrating an example of a complete drainage method using the complete drainage system of FIG. 1;

FIG. 3 is a flowchart illustrating another example of a complete drainage method using the complete drainage system of FIG. 1;

FIG. 4 is a schematic diagram illustrating a complete drainage system for a hot water tank according to another example embodiment of the invention; and

FIG. 5 is a flowchart illustrating a complete drainage method using the complete drainage system of FIG. 4.

### DETAILED DESCRIPTION OF THE INVENTION

The present invention may be modified in various ways and may take different forms, therefore, specific embodiments will be described in detail in the specification. However, the disclosure is not intended to limit the invention to the particular forms described, and it should be understood to include all modifications, equivalents, and alternatives that fall within the spirit and scope of the invention. In the drawings, similar reference numerals designate corresponding elements, and terms such as “first,” “second,” etc. are merely used to distinguish one element from another, and are not intended to limit the scope of the invention.

The terminology used in the present application is for the purpose of describing particular embodiments only, and is not intended to limit the invention. Unless the context clearly indicates otherwise, the singular forms include the plural. As used herein, the terms “include” and “consist of” indicate the presence of features, numerals, steps, operations, elements, parts, or combinations thereof described in the specification, but do not preclude the possibility of the presence or addition of one or more other features, numerals, steps, operations, elements, parts, or combinations thereof.

Hereinafter, the present invention will be explained in detail with reference to the accompanying drawings.

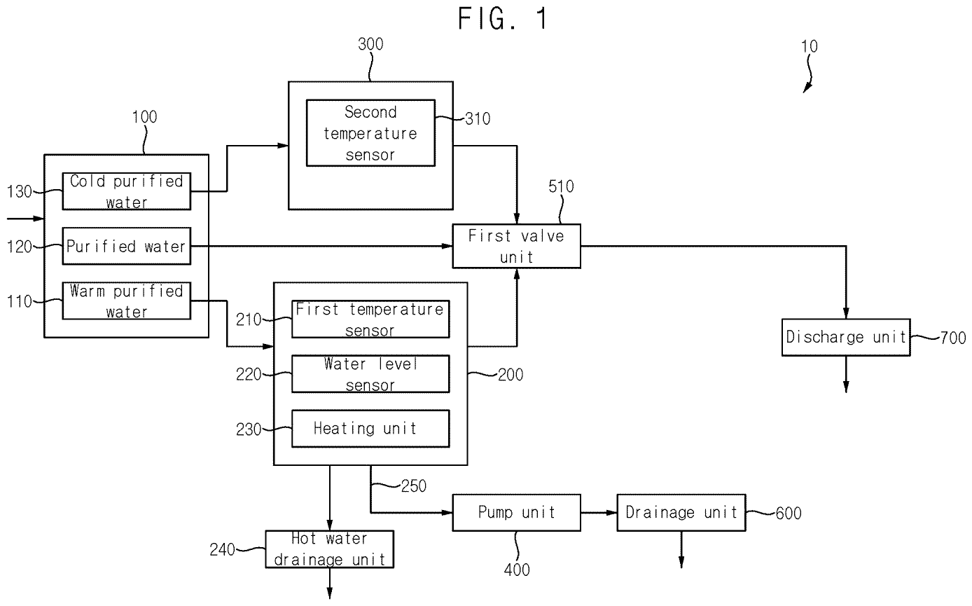

FIG. 1 is a schematic diagram illustrating a complete drainage system for a closed hot water tank according to an example embodiment of the invention.

Referring to FIG. 1, a complete drainage system 10 for a closed hot water tank (hereinafter referred to as a system) according to the present example embodiment, includes an inflow unit 100, a hot water tank 200, a cold water tank 300, a pump unit 400, a first valve unit 510, a drainage unit 600, and a discharge unit 700. Furthermore, the system 10 includes first and second temperature sensors 210 and 310, a water level sensor 220, a heating unit 230, and a hot water drainage unit 240.

The inflow unit 100 is configured such that purified water filtered through a filter is introduced. For convenience of description, purified water provided to the hot water tank 200 is indicated as warm purified water 110, purified water provided to the cold water tank 300 is indicated as cold purified water 130, and purified water discharged as it is is indicated as purified water 120. However, the purified water provided through the inflow unit 100 is respectively branched and provided to the hot water tank 200 and the cold water tank 300, and then is heated and cooled in the hot water tank 200 and the cold water tank 300, respectively, to be stored as hot water and cold water.

That is, hereinafter, the warm purified water 110 provided to the hot water tank 200 is heated in the hot water tank 200 and stored as hot water, and the cold purified water 130 provided to the cold water tank 300 is cooled in the cold water tank 300 and stored as cold water.

The hot water tank 200 stores the warm purified water 110 provided through the inflow unit 100. In this case, the heating unit 230 is provided to heat the warm purified water 110 provided to the hot water tank 200 to a preset temperature, for example, 90 degrees or higher. Thus, the temperature of the hot water stored in the hot water tank 200 always maintains the preset temperature, and is discharged to the outside as hot water by discharge control from the outside.

Meanwhile, the first temperature sensor 210 is provided in the hot water tank 200, and the first temperature sensor 210 senses a temperature of the hot water stored in the hot water tank 200. Thus, not only may it be monitored that the temperature of the hot water stored in the hot water tank 200 is maintained at the preset temperature exemplified above, but also, as described below, a criterion may be provided as to whether the hot water tank 200 may be completely drained.

In addition, the water level sensor 220 is provided in the hot water tank 200, and the water level sensor 220 senses a water level of the hot water stored in the hot water tank 200. In this case, although one sensor is exemplified in the drawings, two sensors may be provided, namely a low water level sensor that senses a low-water level of the hot water tank 200 and a full-water level sensor that senses a full-water level.

Through the water level sensor 220, it may be determined whether the hot water tank 200 has been completely drained by sensing the low-water level of the hot water tank 200. In addition, it may be determined whether the hot water stored in the hot water tank 200 has reached a full-water level, thereby controlling the provision of the warm purified water 110 introduced from the inflow unit 100. Furthermore, when performing complete drainage of the hot water tank 200 as described below, the warm purified water 110 needs to be introduced first. At this time, if the hot water tank 200 already corresponds to a full-water level with hot water, a water level determination for forcibly draining the hot water through the hot water drainage unit 240 may also be performed.

As shown, the hot water tank 200 is connected to the discharge unit 700 through the first valve unit 510. Thus, when hot water discharge control is input from the outside, hot water is provided to the outside through the discharge unit 700, and a user may drink the hot water.

Meanwhile, as shown, the first valve unit 510 is connected to a line to which the purified water 120 of the inflow unit 100 is provided, and is also connected to a line to which the cold purified water 130 of the cold water tank 300 described below is provided, and is operated to selectively provide the purified water, the hot water, and the cold water to the outside according to a discharge control command.

In the present example embodiment, the hot water tank 200 is connected to the drainage unit 600 through a drainage line 250 for complete drainage. In this case, the pump unit 400 is provided between the hot water tank 200 and the drainage unit 600. Thus, when performing complete drainage of the hot water tank 200, the pump unit 400 is operated to guide the hot water stored in the hot water tank 200 to be drained to the drainage unit 600.

Here, so-called complete drainage means completely draining the hot water stored in the hot water tank 200 to the drainage unit 600. However, if all of the hot water stored in the hot water tank 200 is completely and fully drained, problems in operation may occur, and therefore complete drainage is defined as being drained only to a preset low-water level. In addition, a degree of the preset low-water level may be preset in consideration of a structure of the hot water tank 200. Whether drainage has been performed down to the low-water level may be sensed through the water level sensor 220 described above.

Accordingly, hereinafter, a state in which hot water of the hot water tank 200 has been drained down to the preset low-water level through the water level sensor 220 is defined as so-called complete drainage.

In addition, when the hot water stored in the hot water tank 200 is completely drained as described above, if such complete drainage is performed periodically, generation of contaminants such as scale generated in the hot water tank 200 by the hot water stored in the hot water tank 200 may be minimized.

In particular, in the case of the hot water tank 200 in the present example embodiment, hot water is discharged to the outside only when hot water discharge control from the outside is input in a state where a predetermined amount or more of hot water at a high temperature is stored, so that a state in which hot water is stored in an amount greater than or equal to a predetermined amount may be maintained for a long time. Therefore, contaminants such as scale may be generated due to long-term storage of the hot water. Of course, in the case of contaminants such as scale, cleaning may be performed using a separate cleaning agent. However, this requires separate professional personnel, and a lot of cost and time may be required, such as using a separate cleaning agent for cleaning.

Accordingly, in the present example embodiment, the hot water stored in the hot water tank 200 is subjected to so-called complete drainage at a preset regular cycle to minimize the generation of contaminants such as scale in the hot water tank 200.

Meanwhile, when the hot water stored in the hot water tank 200 is drained through the drainage unit 600, the hot water must pass through the pump unit 400 located on the hot water drainage line 250, and the pump unit 400 may be damaged by high heat. In particular, since the hot water stored in the hot water tank 200 is at a high temperature of about 90 degrees or higher, if it is drained as it is to the drainage unit 600, the pump unit 400 may be damaged by the high temperature of the hot water.

Therefore, in order to completely drain the hot water stored in the hot water tank 200, the temperature of the hot water must be lowered, and drainage must be performed at a temperature at which the pump unit 400 is not damaged. To this end, in the present example embodiment, before complete drainage of the hot water of the hot water tank 200, the warm purified water 110 is provided to the hot water tank 200 to induce a decrease in a temperature of the hot water of the hot water tank 200 due to mixing of the warm purified water with the hot water.

Specific detailed explanation of lowering the temperature before complete drainage of the hot water of the hot water tank 200 will be described simultaneously with a description of a complete drainage method described below.

The hot water drainage unit 240 forcibly drains the hot water stored in the hot water tank 200, and is connected through a line separate from the hot water tank 200. As described above, before complete drainage of the hot water tank 200, the warm purified water 110 is provided to the hot water tank 200, and the hot water tank 200 may already store hot water at a full-water level. In addition, as the warm purified water 110 is provided to the hot water tank 200 and is mixed with the hot water, a water level of the hot water tank 200 may reach a full-water level.

In this case, based on a full-water level sensing result of the water level sensor 220, the hot water drainage unit 240 forcibly drains the hot water stored in the hot water tank 200 to the outside. Thus, the warm purified water 110 may be continuously provided to the hot water tank 200, thereby lowering the temperature of the hot water stored in the hot water tank 200 to a temperature at which drainage is possible.

Meanwhile, the cold water tank 300 stores the cold purified water 130 provided through the inflow unit 100. As described above, after receiving the cold purified water 130, cooling is performed through a separate cooling unit not shown to store the water as cold water at a certain temperature. In this case, the second temperature sensor 310 is provided in the cold water tank 300 to sense a temperature of the cold water stored in the cold water tank 300.

Cold water stored in the cold water tank 300 is discharged to the discharge unit 700 through the first valve unit 510 by external cold water discharge control. In this case, the operation of the first valve unit 510 is as described above.

Hereinafter, a complete drainage method using the system 10 of FIG. 1 will be described in more detail.

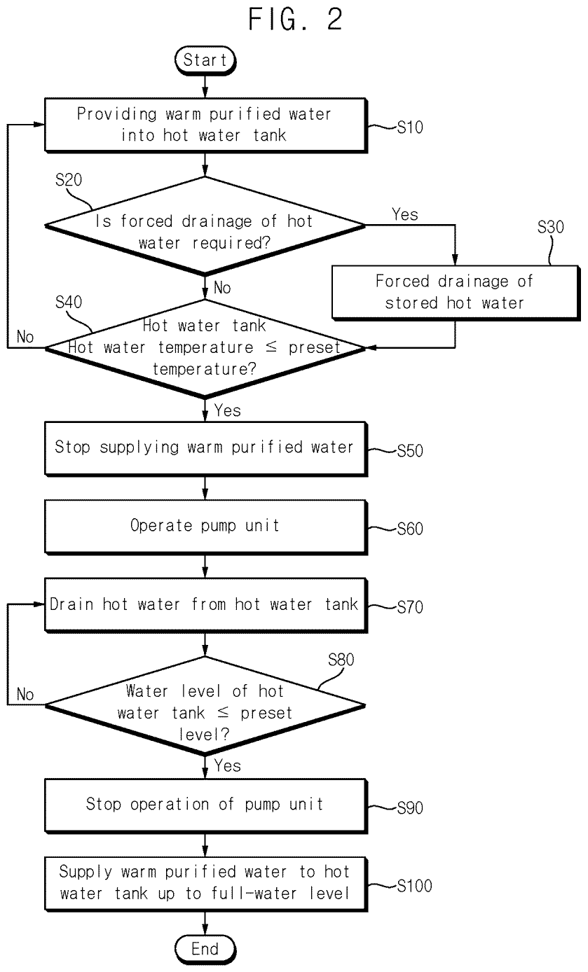

FIG. 2 is a flowchart illustrating an example of a complete drainage method using the complete drainage system of FIG. 1.

Hereinafter, a complete drainage method using the system 10 of FIG. 1 relates to a method for completely draining hot water of the hot water tank 200 to the outside when a preset regular cycle is reached. Accordingly, when the preset regular cycle is reached and the time for completely draining the hot water of the hot water tank 200 arrives, the following steps are performed.

First, referring to FIG. 2, the warm purified water 110 is provided to the hot water tank 200 (step S10). As the warm purified water 110 is provided to the hot water tank 200, the temperature of the hot water already stored in the hot water tank 200 decreases. That is, although the hot water already stored in the hot water tank 200 is heated to about 90 degrees or higher by the heating unit 230, the warm purified water 110 has a relatively low temperature, so the temperature of the hot water stored in the hot water tank 200 decreases due to mixing.

At this time, the water level sensor 220 determines whether the amount of hot water already stored in the hot water tank 200 corresponds to a full-water level, or whether the hot water tank 200 reaches a full-water level as the warm purified water 110 is provided to the hot water tank 200. Thus, when the hot water tank 200 reaches a full-water level, that is, when it is determined that the hot water of the hot water tank 200 should be forcibly drained (step S20), the hot water of the hot water tank 200 is forcibly drained through the hot water drainage unit 240 (step S30).

Meanwhile, even when the hot water is forcibly drained as described above or drainage is not required because the full-water level has not been reached, the first temperature sensor 210 continuously senses the temperature of the hot water in the hot water tank 200 (step S40). Thus, when the temperature of the hot water of the hot water tank 200 decreases to a preset temperature or lower by mixing with the warm purified water 110 (step S40), the provision of the warm purified water 110 is stopped (step S50).

At this time, the preset temperature is a temperature at which the pump unit 400 is not damaged, for example, 70 degrees, but is not limited thereto.

Therefore, when the temperature of the hot water of the hot water tank 200 decreases to the preset temperature or lower (step S40), the provision of the warm purified water 110 is stopped (step S50), and the pump unit 400 is operated (step S60).

Thus, through the hot water drainage line 250 connected to the hot water tank 200, the hot water passes through the pump unit 400 and is drained to the drainage unit 600 (step S70). In addition, since the temperature of the hot water is the preset temperature or lower in this drainage process, the pump unit 400 is not damaged and continuously operates so that drainage to the drainage unit 600 may be smoothly performed.

Such drainage to the drainage unit 600 continues until the water level of the hot water tank 200 measured by the water level sensor 220 reaches the preset low-water level (step S80). Thus, when the water level of the hot water tank 200 reaches the low-water level, the operation of the pump unit 400 is stopped (step S90), and drainage of the hot water stored in the hot water tank 200 is completed. Through this, the hot water tank 200 is so-called completely drained. In addition, contaminants such as scale generated in the hot water tank 200 are minimized through such complete drainage.

That is, when a hot water tank having a closed structure as in the present example embodiment is applied, the possibility of scale generation increases when hot water is stored in the hot water tank 200 for a long time. Therefore, by periodically performing so-called complete drainage of the hot water tank 200, the generation of contaminants such as scale in the hot water tank 200 may be minimized.

When complete drainage of the hot water tank 200 is completed as described above, the warm purified water 110 is provided to the hot water tank 200 to fill the tank, and is heated by the heating unit 230 to be stored as hot water suitable for drinking. At this time, the filling degree of the hot water tank 200 may be performed until the full-water level is reached by the water level sensor 220 (step S100).

In the complete drainage method using the system 10 illustrated in FIG. 2, the key is to provide the warm purified water to the inside of the hot water tank to lower the temperature of the hot water drained through the pump unit by mixing with the hot water. Alternatively, it is also possible to omit the supply of the warm purified water and lower the temperature of the hot water of the hot water tank.

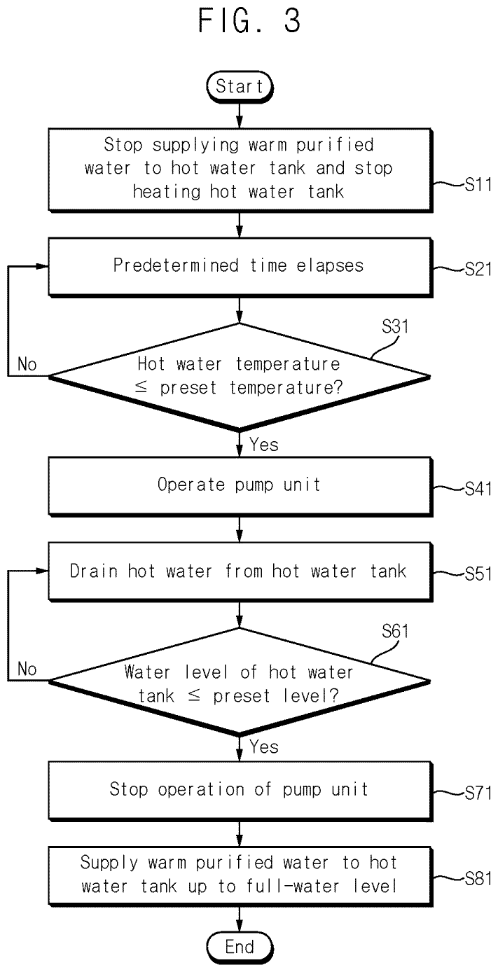

FIG. 3 is a flowchart illustrating another example of a complete drainage method using the complete drainage system of FIG. 1.

That is, in the complete drainage method using the system 10 illustrated in FIG. 3, the supply of separate warm purified water is omitted, and the key is to lower the temperature of the hot water in the hot water tank 200 to the preset temperature or lower by allowing a certain time to elapse and then draining.

Specifically, referring to FIG. 3, in the complete drainage method, first, when the cycle for complete drainage of the preset hot water tank 200 arrives, the supply of warm purified water to the hot water tank 200 and the heating of the hot water tank 200 are stopped (step S11). Thus, no additional warm purified water is supplied to the hot water tank 200, and heating is no longer performed.

Then, the hot water tank 200 is left as it is, and a certain time is allowed to elapse (step S21). In this case, the time for leaving the hot water tank 200 is not particularly limited, and it is sufficient to allow the time to elapse until the temperature of the hot water stored in the hot water tank 200 decreases to the preset temperature or lower (step S31). The temperature of the hot water stored in the hot water tank 200 is sensed by the first temperature sensor 210, and the preset temperature is a temperature at which the pump unit 400 is not damaged, as described above.

Thus, when the temperature of the hot water stored in the hot water tank 200 decreases to the preset temperature or lower, the pump unit 400 is operated (step S41), and the hot water stored in the hot water tank 200 is drained through the drainage unit 600 (step S51).

This drainage of the hot water is performed until the hot water of the hot water tank 200 reaches a so-called low-water level as in FIG. 2 (step S61). After the hot water is completely drained, the operation of the pump unit 400 is stopped (step S71), and after the warm purified water 110 is filled again to the full-water level in the hot water tank 200 (step S81), the water is heated and becomes ready for hot water discharge to the outside. The step of refilling the warm purified water after complete drainage is substantially the same as described with reference to FIG. 2.

As described above, in the complete drainage method, the temperature of the hot water of the hot water tank is lowered without providing separate warm purified water, but by simply allowing a certain time to elapse so that the temperature of the hot water naturally decreases, thereby enabling the system control to be implemented relatively easily.

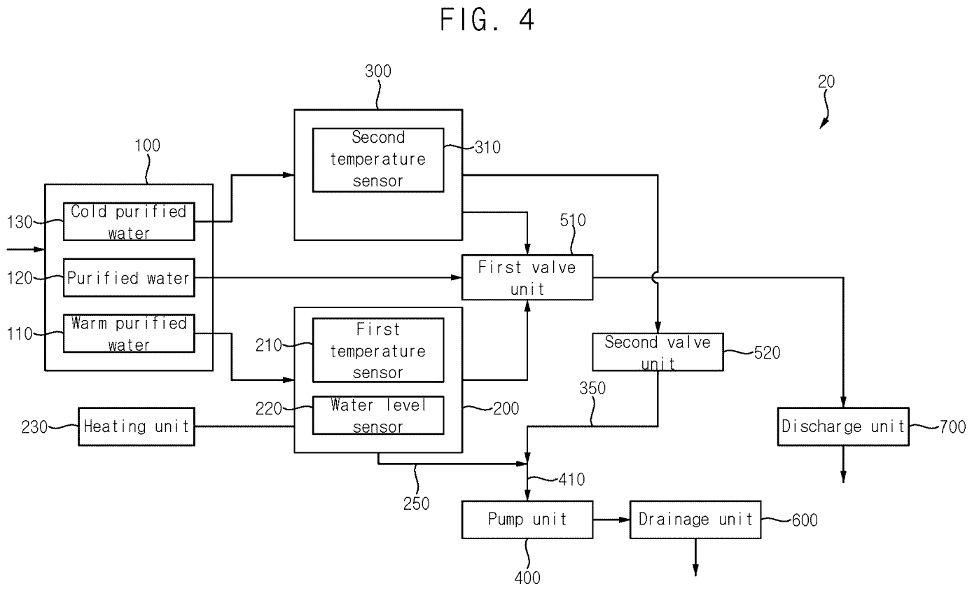

FIG. 4 is a schematic diagram illustrating a complete drainage system for a hot water tank according to another example embodiment of the invention.

The system 20 according to the present example embodiment is substantially the same as the system 10 described with reference to FIG. 1, except that the system is configured such that hot water and cold water are directly mixed to perform complete drainage. Therefore, the same reference numerals are used for the same components, and repeated descriptions are omitted.

Referring to FIG. 4, in the system 20 according to the present example embodiment, a second valve unit 520 is additionally provided, and a hot water drainage line 250 and a cold water drainage line 350 are connected to be combined with each other.

Specifically, when completely draining the hot water of the hot water tank 200, the hot water drainage line 250 through which the hot water is drained is not directly connected to the pump unit 400, but is connected to the cold water drainage line 350.

In this case, the cold water drainage line 350 is connected to the cold water tank 300 and is a line through which cold water is drained. As shown, the cold water drainage line 350 and the hot water drainage line 250 are combined with each other and then connected to the pump unit 400 through a mixed drainage line 410.

Thus, the hot water discharged from the hot water tank 200 is mixed with the cold water discharged from the cold water tank 300, and after the temperature decreases, the mixed water is provided to the pump unit 400 through the mixed drainage line 410. That is, the hot water stored in the hot water tank 200 may be about 90 degrees or higher, and the cold water stored in the cold water tank 300 may be 10 degrees or lower. Therefore, when the hot water and the cold water are mixed, the temperature becomes 50 degrees or lower, and even when the mixed purified water of the cold water and the hot water is provided to the pump unit 400, the pump unit 400 is not damaged by the high temperature.

Accordingly, in the present example embodiment, without providing separate warm purified water 110 to lower the temperature of the hot water of the hot water tank 200, the hot water of the hot water tank 200 may be completely drained while preventing damage to the pump unit 400.

Meanwhile, as shown, the second valve unit 520 is provided on the cold water drainage line 350 and is opened when the hot water of the hot water tank 200 is completely drained, thereby allowing the cold water to be provided so as to be mixed with the hot water.

As described above, in order to maintain a state in which the hot water of the hot water tank 200 is mixed with the cold water of the cold water tank 300 and drained in a state where the temperature is lowered, the capacity of the hot water of the hot water tank 200 must be smaller than the capacity of the cold water of the cold water tank 300. That is, if the capacity of the hot water of the hot water tank 200 is large, all of the cold water of the cold water tank 300 may be exhausted before the hot water of the hot water tank 200 is completely drained. In this case, since the cold water may not be mixed with the hot water, the temperature of the hot water provided to the pump unit 400 may become higher than the preset temperature.

Therefore, in order to prevent damage to the pump unit 400 and to maintain the temperature of the hot water provided to the pump unit 400 at or below the preset temperature until the hot water of the hot water tank 200 is completely drained, the amount of cold water stored in the cold water tank 300 must always be greater than the amount of hot water stored in the hot water tank 200.

To this end, although not shown, a separate water level sensor is also provided in the cold water tank 300 to check the water level of the cold water tank 300 in advance when starting complete drainage of the hot water tank 200. Thus, if it is determined that the amount of cold water is insufficient, additional cold purified water 130 may be provided through the inflow unit 100, cooled, and the capacity of the cold water sufficiently filled before starting complete drainage of the hot water tank 200.

Hereinafter, a complete drainage method using the system 20 of FIG. 4 will be described in more detail.

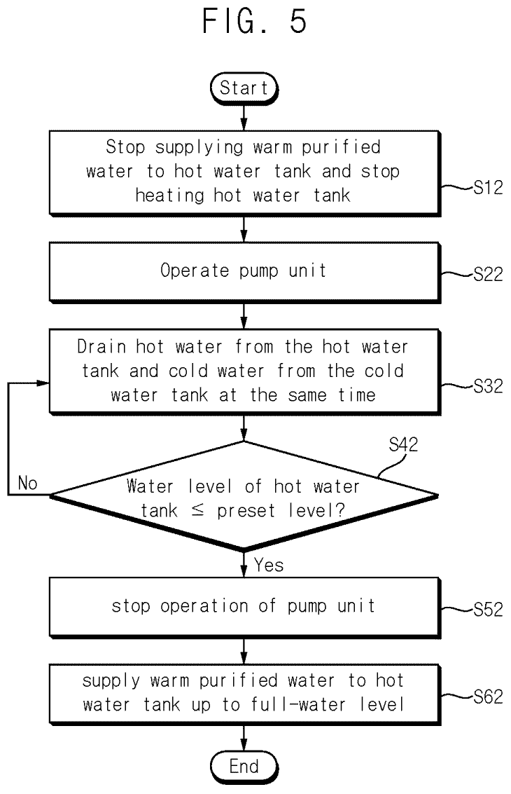

FIG. 5 is a flowchart illustrating a complete drainage method using the complete drainage system of FIG. 4.

Hereinafter, a complete drainage method using the system 20 of FIG. 5 also relates to a method for completely draining hot water of the hot water tank 200 to the outside when a preset regular cycle is reached. Accordingly, when the preset regular cycle is reached and the time for completely draining the hot water of the hot water tank 200 arrives, the following steps are performed.

Specifically, referring to FIG. 5, in the complete drainage method, first, when the cycle for complete drainage of the preset hot water tank 200 arrives, the supply of warm purified water to the hot water tank 200 and the heating of the hot water tank 200 are stopped (step S12). Thus, no additional warm purified water is supplied to the hot water tank 200, and heating is no longer performed.

Thereafter, in the present example embodiment, no separate time lapse or provision of warm purified water is performed, and the second valve unit 520 is opened, and the pump unit 400 immediately operates to start drainage (step S22). Of course, as described above, since the amount of cold water must be maintained larger to keep the temperature of the hot water at or below the preset temperature until the hot water is completely drained, the water level of the cold water stored in the cold water tank 300 may be checked, and if necessary, cold purified water 130 may be additionally filled into the cold water tank 300.

As described above, as the second valve unit 520 is opened and the pump unit 400 operates, drainage of the hot water of the hot water tank 200 begins through the hot water drainage line 250, and at the same time, drainage of the cold water of the cold water tank 300 begins through the cold water drainage line 350. Thus, the hot water and the cold water are mixed with each other, pass through the pump unit 400 via the mixed drainage line 410, and are drained to the drainage unit 600 (step S32).

This simultaneous drainage of the hot water and the cold water is performed until the hot water of the hot water tank 200 reaches a so-called low-water level as in FIG. 2 (step S42). After the hot water is completely drained, the operation of the pump unit 400 is stopped (step S52), and after the warm purified water 110 is filled again to the full-water level in the hot water tank 200 (step S62), it is heated and becomes ready for hot water discharge to the outside. The step of refilling the warm purified water after complete drainage is substantially the same as described with reference to FIG. 2.

Meanwhile, in the present example embodiment, as the warm purified water 110 is filled into the hot water tank 200, the cold purified water 130 is also provided to the cold water tank 300, filled to the full-water level, and cooled to be in a state capable of cold water discharge to the outside.

As described above, in the complete drainage method, the temperature of the hot water of the hot water tank is not lowered by providing separate warm purified water, nor is it necessary to allow a lapse of time. Instead, hot water and cold water are immediately mixed and drained, thereby not only making system control relatively easy but also minimizing the time required to complete drainage.

According to exemplary embodiments of the present invention, by completely draining hot water in the hot water tank to the outside at regular intervals, scale generated in the hot water tank may be effectively removed. In particular, in the case of a hot water tank having a closed structure, since hot water is stored in the hot water tank for a long period of time, the possibility of scale generation is high, and effective scale management may be achieved while omitting a separate cleaning operation.

In this case, if the hot water stored in the hot water tank is drained as it is, there is a high possibility of damaging the pump unit due to the high temperature. Therefore, by lowering the temperature of the hot water to a temperature equal to or lower than a temperature at which the pump unit is not damaged, and then draining the hot water stored in the hot water tank, damage to a piping system including the pump unit may be minimized.

As a method for lowering the temperature of the hot water, warm purified water may be provided to the hot water tank so that the temperature is lowered by mixing with the hot water, or the temperature may be naturally lowered by allowing the hot water stored in the hot water tank to stand for a predetermined time. In particular, when the warm purified water is provided, if the water level of the hot water tank reaches a full-water level due to the provision of the warm purified water, the temperature of the hot water stored in the hot water tank may be effectively lowered to a preset temperature or lower by forcibly draining the hot water to the outside.

Alternatively, without providing separate warm purified water or waiting for a lapse of time, the temperature of the hot water provided to the pump unit may be directly lowered to a preset temperature or lower by draining mixed water in which the hot water discharged from the hot water tank and cold water discharged from a cold water tank are mixed, thereby simply and effectively achieving complete drainage of the hot water in the hot water tank.

In particular, in this case, when the hot water of the hot water tank and the cold water of the cold water tank are mixed, a low temperature that does not damage the pump unit may be obtained without separate temperature sensing, so that more direct and faster drainage of hot water may be achieved.

Meanwhile, it is sufficient that the hot water in the hot water tank is drained to a preset low-water level, and by measuring the water level of the hot water tank through a separate water level sensor, the completion time point of complete drainage may be accurately determined.

In particular, when drainage is performed by mixing with cold water, if the hot water tank is formed to have a smaller size than the cold water tank, the temperature of the hot water mixed with the cold water provided to the pump unit until the hot water tank reaches the low-water level is maintained at a preset temperature or lower, thereby implementing stable complete drainage while minimizing the possibility of damage to the pump unit.

Having described exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A complete drainage system comprising:
a hot water tank in which hot water is stored;
a discharge unit configured to discharge the hot water to an outside for drinking;
a drainage unit configured to drain the hot water to the outside; and
a pump unit connected between the hot water tank and the drainage unit,
wherein when a temperature of the hot water in the hot water tank reaches a preset temperature or lower at which the pump unit is not damaged, the hot water is completely drained to the drainage unit.

2. The complete drainage system of claim 1, further comprising an inflow unit configured to provide warm purified water into the hot water tank,
wherein as the warm purified water is provided into the hot water tank, the temperature of the hot water stored in the hot water tank decreases.

3. The complete drainage system of claim 2, further comprising a hot water drainage unit additionally connected to the hot water tank without passing through the pump unit,
wherein when the hot water tank reaches a full-water level as the warm purified water is provided, the hot water stored in the hot water tank is forcibly drained through the hot water drainage unit.

4. The complete drainage system of claim 2, further comprising a first temperature sensor configured to sense the temperature of the hot water in the hot water tank,
wherein when the temperature of the hot water sensed by the first temperature sensor reaches the preset temperature or lower, the hot water is drained through the pump unit and the drainage unit.

5. The complete drainage system of claim 1, further comprising a water level sensor configured to sense a water level of the hot water tank,
wherein when the water level sensed by the water level sensor reaches a preset low-water level, drainage to the drainage unit is stopped.

6. The complete drainage system of claim 1, wherein when the temperature of the hot water stored in the hot water tank decreases over time and reaches the preset temperature or lower, the hot water is drained through the pump unit and the drainage unit.

7. The complete drainage system of claim 1, further comprising a cold water tank in which cold water is stored,
wherein the cold water is discharged to the discharge unit for drinking, or is mixed with the hot water discharged from the hot water tank and drained to the drainage unit.

8. The complete drainage system of claim 7, wherein a hot water drainage line connected to the hot water tank and through which the hot water is discharged is combined with a cold water drainage line connected to the cold water tank and through which the cold water is discharged, and is then connected to the pump unit.

9. The complete drainage system of claim 7, wherein a capacity of the hot water tank is smaller than a capacity of the cold water tank.

10. The complete drainage system of claim 1, wherein the complete drainage of the hot water in the hot water tank to the drainage unit is performed at a predetermined cycle requiring cleaning of the hot water tank.

11. A complete drainage method comprising:
sensing a temperature of hot water stored in a hot water tank;
draining the hot water to a drainage unit, when the temperature of the hot water reaches a preset temperature or lower at which a pump unit is not damaged;
stopping drainage to the drainage unit, when a water level of the hot water tank reaches a preset low-water level; and
supplying warm purified water to the hot water tank up to a full-water level.

12. The complete drainage method of claim 11, further comprising:
before the step of sensing the temperature of the hot water, supplying warm purified water to the hot water tank,
wherein as the warm purified water is provided, the temperature of the hot water stored in the hot water tank decreases.

13. The complete drainage method of claim 12, further comprising:
when the hot water tank reaches a full-water level as the warm purified water is provided, forcibly draining the hot water stored in the hot water tank through a hot water drainage unit.

14. The complete drainage method of claim 11, further comprising:
before the step of sensing the temperature of the hot water, maintaining the hot water stored in the hot water tank for a predetermined time,
wherein as the predetermined time elapses, the temperature of the hot water stored in the hot water tank decreases.

15. A complete drainage method comprising:
draining hot water stored in a hot water tank and cold water stored in a cold water tank to a drainage unit at the same time;
stopping drainage to the drainage unit, when a water level of the hot water tank reaches a preset low-water level; and
supplying warm purified water to the hot water tank up to a full-water level.

16. The complete drainage method of claim 15, wherein in the step of draining the hot water and the cold water to the drainage unit at the same time,
the hot water discharged from the hot water tank and the cold water discharged from the cold water tank are mixed with each other and drained to the drainage unit through a pump unit at a temperature equal to or lower than a preset temperature.
